(19) United States
(12) Patent Application Publication
(10) Pub. No.: US 2010/0276513 A1
(43) Pub. Date: Nov. 4, 2010

(54) LIQUID-DISPENSING STATION

(76) Inventor: Kevin Huff, Austin, TX (US)

Correspondence Address: Edward J. Marshall, Attorney at Law, 8705 Shoal Creek Blvd., Suite 202, Austin, TX, 78757, US

(21) Appl. No.: 12/434,025

(22) Filed: May 1, 2009

(51) Int. Cl. B05B 1/20; A01G 25/09

(52) U.S. Cl. 239/266; 414/809; 239/1

(57) ABSTRACT

A portable liquid-dispensing station includes a portable stand and a portable tank, each of which is capable of being carried by a single laborer. When assembled, the tank can sit on top of, and be supported by, the stand. A first opening formed at an upper portion of the tank can receive a liquid to be dispensed, and one or more openings formed in a lower portion of the tank allow the liquid in the tank to be dispensed through multiple dispensing valves. The dispensing valves are spaced around the outside of the tank, and operate independently to permit multiple users to draw liquid from the tank at the same time. A misting system can use a battery operated pump to draw liquid from the tank and pump the liquid to misters. A canopy can also be included to shade the tank, and the people using the portable station.

### FIELD

This disclosure relates generally to fluid delivery systems, and more particularly to stations for dispensing liquids.

### BACKGROUND

Various methods and devices for delivering potable water to remote locations have been used in various situations and to satisfy particular types of needs. The US military, for example, uses what are sometimes referred to as water buffaloes to provide potable water to troops in the field. These water buffaloes are large tanks towed on a trailer, and are designed to provide water to a large number of troops. At the other extreme are canteens and similar containers used to provide water for individuals while hiking, or while otherwise away from any easily accessible source of potable water. Other methods known for dispensing liquids to individuals or larger groups, providing personal sized bottles or cans of water or other fluids, or using water coolers to provide water to workers in office situations.

Known methods of providing liquids are, however, less-than-perfect. For example, canteens designed to hold a small amount of liquid but can be carried by a single person. Trailer-towed water tanks can present logistical problems, and may involve excessively high equipment costs. Providing each member of a large group within individual bottle of water can also be cost prohibitive, and can result in large qualities of waste, which may be undesirable, especially given current environmental concerns. Water coolers such as those found in offices, can be particularly unsuited for use in locations where no electricity is available, and are also likely to be cost prohibitive.

### SUMMARY

A portable, liquid-dispensing station includes a portable stand capable of being carried by a single laborer, and a portable tank also capable of being carried, by a single laborer when empty. The portable stand has a frame with a lower portion configured to be placed on a supporting surface, and an upper portion configured to receive the portable tank and support the portable tank when filled with a liquid, for example water. The portable tank is configured to be received and seated upon the upper portion of the frame. The tank has an opening in the top to receive a liquid to be dispensed, and one or more openings formed in the lower part of the tank.

Multiple liquid-dispensing valves can be spaced around the perimeter of the tank to allow the liquid in the tank to be dispensed when activated by a user. These dispensing valves can be each be attached to the portable tank through different openings formed in the portable tank, or the valves can be attached to a conduit having an inlet connected to the tank, and configured to be placed at least partially about the perimeter of the portable tank.

The stand can be configured to support the tank so that at least one of the valves is positioned between about waist level and shoulder level of an average-height American adult when the tank is supported by the portable stand. In some embodiments the stand is between about 32 inches high and 54 inches high. In some embodiments, the stand is stackable with other stands.

The liquid-dispensing station can also include a canopy, which may be free standing, or fastened to the portable stand. The canopy can have multiple struts capable of being fastened to the stand. The canopy can also include a frame that has support members extending on all sides beyond the outer edges of the portable tank and the portable stand, and has a flexible fabric attached to the canopy frame. In some embodiments, the canopy is adjustable to provide shade to the tank and to a user operating the valves. In some embodiments the canopy can be a four-legged, free-standing canopy.

In some embodiments, the station includes a misting system configured to draw liquid from the tank and push the liquid through multiple misting nozzles. The misting system can include a battery operated pump that draws fluid from an auxiliary opening in the tank, and a circuit of misting nozzles.

Various embodiments can be realized as a method including transporting, in a single vehicle, a liquid to be dispensed, a cooling material, a dispensing container, and a container stand to a setup location. Both the dispensing container and the container stand are constructed to be sufficiently lightweight to be carried by a single laborer, the dispensing container includes a plurality of dispensing valves spaced about at least part of its lower portion, and a first opening formed in an upper portion of the dispensing container. One or more workers unload the container stand and the dispensing container, unload at least a portion of the cooling material from the transport vehicle, and put some of the cooling material, e.g. ice, in the dispensing container. The dispensing container can be at least partially filled with liquid from the vehicle.

After use, the dispensing system can be disassembled by removing the dispensing container from the container stand, and storing the dispensing container and the container stand on the single vehicle. Additionally, in some embodiments rubbish generated in conjunction with using the dispensing system is also collected and placed on the vehicle, and the container, stand, and rubbish are transported away.

### BRIEF DESCRIPTION OF THE DRAWINGS

FIG. 1 is a side view of a liquid-dispensing system including a tank and stand according to embodiments of the present disclosure;

FIG. 2 is a perspective view of a liquid-dispensing system including a mister according to embodiments of the present disclosure;

FIG. 3 is a perspective view of the liquid-dispensing system including a tank, stand, canopy, and misters according to embodiments of the present disclosure;

FIG. 4 is a flowchart illustrating a method according to embodiments of the present disclosure.

### DETAILED DESCRIPTION

Various dispensing stations disclosed herein can be used to deliver potable water or other liquids to groups of people at remote locations, or at locations where access to drinking water may otherwise be limited. A dispensing station can include a stand, a tank, multiple dispensing valves, a filter, a misting system, and a canopy to provide shade to individuals using the liquid-dispensing system and to assist in keeping a liquid contained in the tank at a desired temperature.

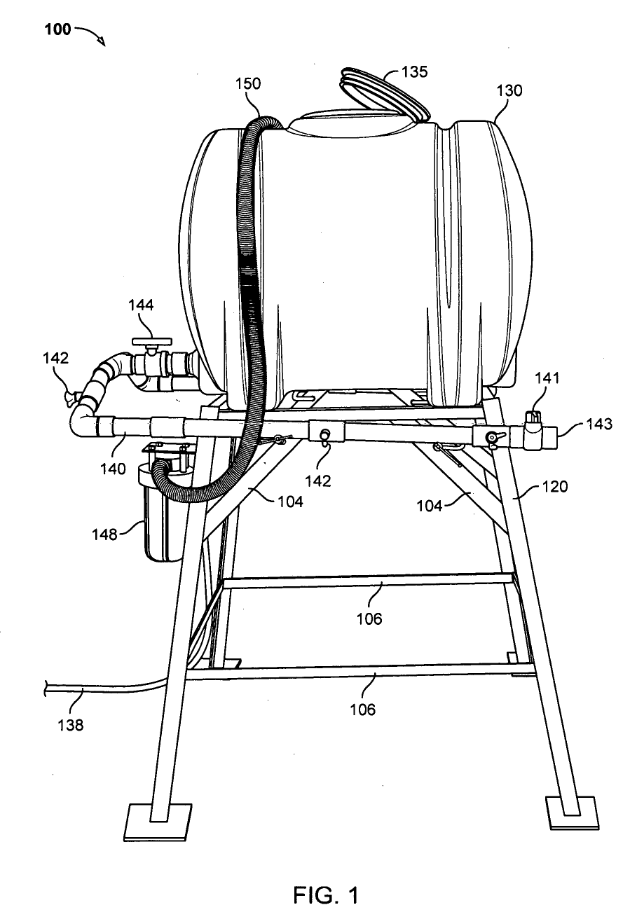

Referring first to FIG. 1, a portable, liquid-dispensing station will be discussed according to various embodiments of the present disclosure. Station 100 can include a stand 120 configured as a metal frame having various angle braces 104 and cross braces 106; a tank 130 capable of holding a liquid to be dispensed, multiple liquid-dispensing valves 142 for dispensing liquid from tank 130. Valves 142 are in fluid communication with tank 130 via shutoff valve 144, which is in turn connected to an opening formed in the side of tank 130. Station 100 also includes a filter 148 connected to hose 150, which can be placed in the top opening of tank 130 for filling tank 130. Fill tube 138 can be used to provide liquid to filter 148.

In operation, fill tube 138 may be connected to a larger tank carried on a vehicle or trailer, a fire hydrant, or to another desired source of liquid. Liquid can be pumped through fill tube 138, through filter 148 and hose 150, then into tank 130. In some embodiments, no filter is included on station 100. Additionally, some embodiments employ a filter at the fluid source. Other embodiments include a screen or filter within tank 130. In at least one embodiment, the liquid used to fill tank 130 is drinking water, but other types of liquid can be used as desired.

After filling tank 132 to a desired level, hose 150 can be removed, or simply draped over the side of tank 130 for later use, and the opening at the top of tank 130 can be closed with lid 135. In at least one embodiment, hose 150 can be connected to tank 130 using a quick-disconnect fitting, or another type of valve affixed to tank 130, or included in lid 135. In some embodiments lid 135 can be a locking lid, or can be formed to require a special tool to be opened or closed, thereby making tampering with the contents of tank 130 more difficult.

After tank 130 is filled to the desired level, and lid 135 has been secured, shutoff valve 144 can be opened to allow the liquid in tank 130 to flow from tank 130 into pipe 140, thereby making the liquid available to be dispensed by liquid-dispensing valves 142. In some embodiments, pipe 140 runs along at least two sides of tank 130, so that a user can access any of multiple liquid-dispensing valves 142 from any side of tank 130. Furthermore, providing pipe 140 on multiple sides of tank 130, with multiple liquid-dispensing valves 142 spaced along pipe 140, can make it easier for more than one person to dispense liquid from tank 130 at the same time another person is doing the same.

In some embodiments, pipe 140 is angled downward, so that an endpoint 143 of tube 140 is closer to the ground than the inlet of pipe 140. In this way, a drain valve 141 can be used to drain the contents of tank 131 after it is no longer desired to dispense fluid from tank 130, or for cleaning purposes. Furthermore, having pipe 140 positioned at a downward angle provides a gravity feed for liquid from tank 130.

Pipe 140 can be formed of a suitable liquid impermeable material that allows connection of liquid-dispensing valves 142. In some embodiments ply vinyl chloride (PVC) pipe is used to form pipe 140. In such an embodiment, various commercially available liquid-dispensing valves 142, shutoff valve 144, and drain valve 141 can be attached to the pipe 140 using PVC glue and commonly known methods of connecting PVC pipes, joints, elbows, and other pieces. In some embodiments, other materials, such as various types of metal, plastic, or rubber tubing, can be used consistent with usability, strength, weight, or other similar design criteria. In some embodiments, pipe 140 can be formed of a material that is not entirely impermeable to liquids.

Stand 120 can be made of angle iron, aluminum pipe, or another suitable material having sufficient strength to support the weight of tank 130 when tank 130 is filled with a liquid to be dispensed. In some embodiments, stand 120 is tapered or otherwise formed to provide easy stackability with other stands or parts of station 100. Note that although stand 120 is illustrated as a frame, stand 120 may be constructed formed into a shell (not illustrated). In some embodiments, stand 120 can also include shelves or other storage capabilities. In some embodiments stand 120 may require some assembly.

Other types of construction can also be used for stand 120 as desired, but regardless of the type of construction, it is preferred for stand 120 to be sufficiently lightweight to allow a single laborer to pick up, move, and put the stand in place without assistance. Furthermore, it is advantageous for the height of stand 120 be between about 32 inches high and 54 inches high, thereby placing liquid-dispensing valves 142 somewhere between about waist and shoulder level of an average adult. By configuring system 100 so that liquid-dispensing valves 142 are between about waist and shoulder high, various embodiments allow easy access to liquid-dispensing valves 142 by a variety of different individuals. In some embodiments, the stand is constructed to conform to various regulatory requirements relating access by disabled individuals.

Tank 130 can be constructed of any of various commercially available materials suitable for holding potable liquids, including various plastics, lightweight metals, or the like. In a preferred embodiment, tank 130 is made of a suitably lightweight material, and shaped so that a single laborer can offload tank 130 from a transport vehicle and placed tank 130 on top of stand 120 without assistance. In some embodiments, tank 130 can be easily stackable with other tanks 130 or with a stand 120 to conserve storage space.

Station 100 can include various mechanisms (not illustrated) to secure tank 130 to stand 120. These locks, fasteners, stakes, cables, or similar devices can be used to discourage tampering or movement of station 100 by unauthorized personnel once assembled. Although not illustrated, linings can be used in tank 130 as desired, including disposable linings.

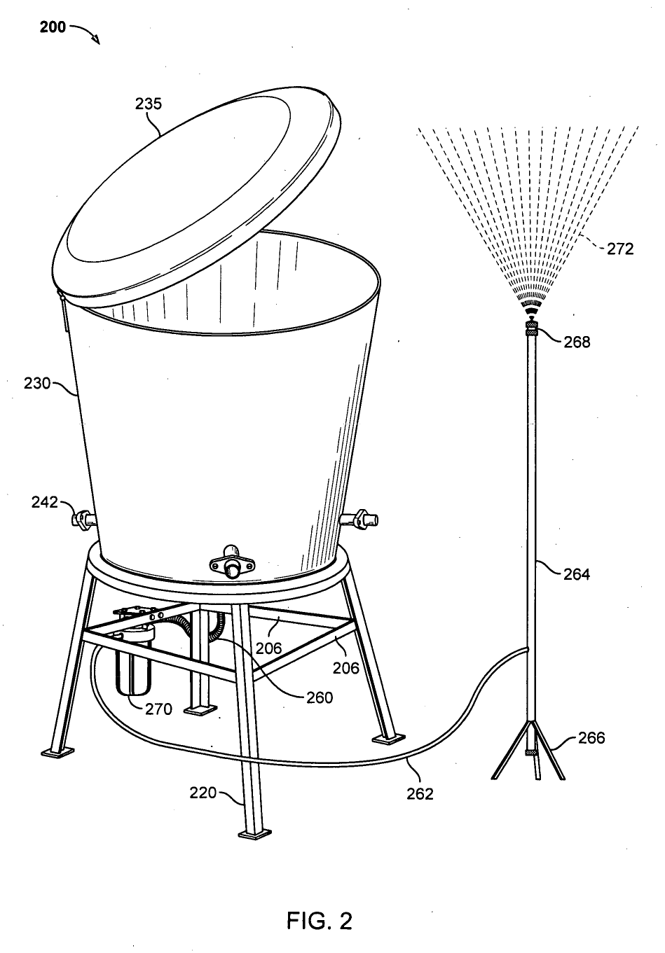

Referring next to FIG. 2, other embodiments of a portable liquid-dispensing station will be discussed. Station 200 includes tank 230 having cover 235 to cover an opening formed in the top portion of tank 230. The bottom portion of tank 230 can include multiple openings spaced around an outer perimeter of tank 230, each of which can have a liquid-dispensing valve 242 attached thereto. Liquid dispensing valves 242 can be manually operated, push-button valves, conventional spigots like those used to connect garden hoses to a home water line, electronically activated valves, or any other type of valve suitable for dispensing liquids. Station 200 also includes stand 220, having cross members 206 for strength. Stand 220 provides support for tank 230, and can be configured to maintain tank 230 at a desired distance from the ground.

An opening (not illustrated) in the bottom of tank 230 is in fluid communication with pump 270 through pump hose 260. Pump 270 can use pump hose 260 to pump fluid from tank 230, and through misting hose 262. In some embodiments, pump 270 is a battery operated pump which is temporarily connected to stand 220. In other embodiments, pump 270 may be connected directly to a bottom portion of tank 230. In some embodiments, pump 270 can be configured to draw liquid from one of the liquid-dispensing valves 242.

Misting hose 262 can be connected to mister 264, which includes a stand 266, and misting nozzle 268, which converts the liquid into a mist 272 of fine droplets. One or more misters 264 can be used to provide evaporative cooling over a variety of areas nearby tank 230.

In a preferred embodiment, tank 230 can be partially filled with ice, with the remainder of tank 230 being filled with potable water. Pump 270 can draw water from tank 230 and pump it to one or more misters 264 to provide evaporative cooling in the area of station 200. The use of one or more misters 264 can help users dispensing water from station 200 to be more comfortable. Furthermore, evaporative cooling provided by one or more ministers 264 can help to regulate the temperature of the water in tank 230. In some embodiments, pump 270 can draw water from a separate reservoir (not illustrated) rather than from tank 230.

Station 200 is, in at least one embodiment, configured to permit a single laborer to offload each of its various components, and assemble station 200 without help from other individuals. To aid in transporting the various elements of station 200, stand 220 and tank 230 can be stackable, one inside the other. To facilitate stackability, some embodiments employ liquid-dispensing valves 242 that are not permanently affixed to tank 230. In some such embodiments, threaded openings in the bottom portion of tank 230 can be used to receive screw-in liquid-dispensing valves. Other types of openings and connections, including bayonet connectors or quick-disconnect couplings may be employed in some embodiments. Furthermore, pump 270 can be connected to stand 220 or tank 230 using various fasteners, adhesives, or mating-type connections.

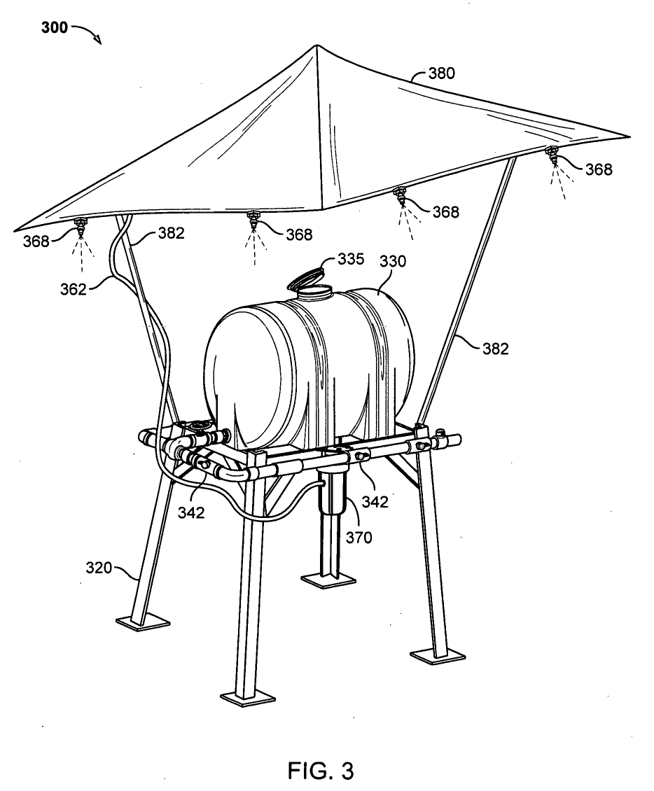

Referring next to FIG. 3, a portable liquid-dispensing station with the canopy is illustrated according to various embodiments of the present disclosure. Station 300 includes a tank 330 having an opening in a top portion, and one or more openings in a bottom portion. The opening in the top portion can be used to fill tank 330 with liquids and ice, while the one or more openings in the bottom portion can be used to connect valves 342 to tank 330. Stand 320 provides support for tank 330 and canopy 380. Canopy 380 includes struts 382, which can be connected to stand 320 and provide support for a frame and fabric portion of canopy 380. Attached to canopy 380 are misting nozzles 368, which are in turn connected to misting tube 362. Pump 370 can be connected to an opening (not shown) in the bottom portion of tank 330, and is used to pump liquid from tank 330 to misting nozzles 368, thereby providing evaporative cooling to help regulate the temperature around tank 330. The mist provided from misting nozzles 368 can also help make users of station 300 more comfortable than they might otherwise be without the use of misters 368.

Canopy 380 can include a frame portion covered completely or partially by canvas, or another suitable shade producing material. In some embodiments, canopy 380 is adjustable to provide shade over all or a portion of tank 330. In some embodiments, canopy 380 extends past all sides of tank 330, so that individuals using Station 330 to dispense liquids can be shaded, and potentially made more comfortable. In some embodiments, a frame portion of canopy 380 extends beyond tank 330 in all directions. In at least one preferred embodiment, the canopy is a free-standing canopy having four legs, and is approximately 10 feet by 10 feet. In other embodiments, canopy 380 can take the form of a collapsible umbrella, which may be attached to a frame member of stand 320.

Each portion of station 300 is preferably configured to be handled by a single laborer, and to permit assembly by a single person. Once assembled, station 300 can be used to provide water or other liquids to people attending gatherings such as backyard barbecues, concerts, political event, races, or other events at which access to other sources of water or liquids may be limited.

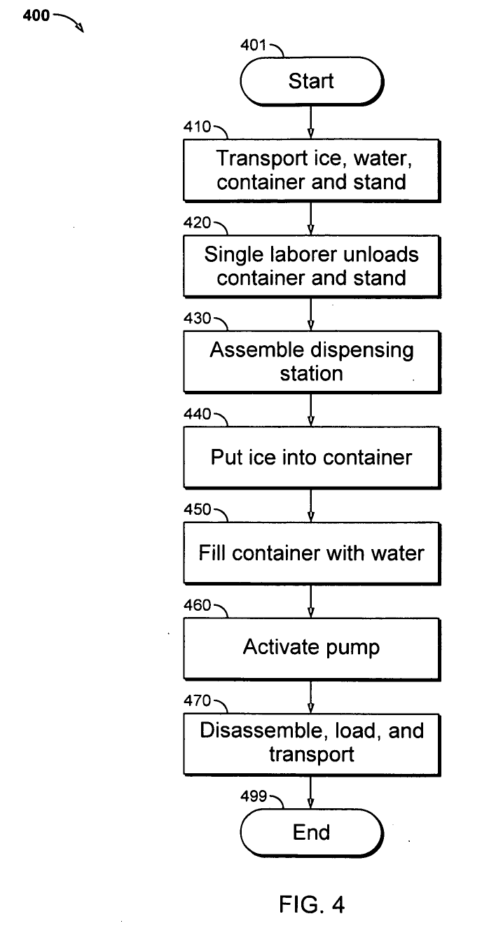

Referring next to FIG. 4, a method according to various embodiments of the present disclosure will be discussed. Method 400 begins as shown by block 401. As shown by block 410, ice, water, a container, a stand, or other elements of a portable liquid-dispensing station can be transported to a desired location. In some embodiments, a single vehicle or trailer can transport all of these elements. The water or other liquid can be transported in a tank for later transfer to a portable dispensing station, ice can be transported in an insulated storage section, and the stands and containers can be stacked and transported in other areas of the vehicle or trailer.

As illustrated by block 420, a single laborer can unload the container, the stand, and any other portions of the portable liquid-dispensing station to be assembled. The other portions of the portable liquid-dispensing station can include a canopy system, and a misting system. In various embodiments, the container and stand are each configured to be able to be handled by a single laborer, so that a single worker, for example the driver of the vehicle transporting the portable liquid-dispensing station, can assemble the station without assistance. In some embodiments, although a single laborer is capable of unloading and assembling the container and stand, it may be preferable to use multiple laborers, with one worker handling the container, another handling the stand, and a third or fourth being responsible for the canopy and the misting system. Regardless of the number of laborers actually used in assembling the portable liquid-dispensing station, in a preferred embodiment a single laborer could assemble the entire system without mechanical assistance, or the assistance of another worker.

As illustrated by block 430, the portable liquid-dispensing station can be assembled by placing the stand may be placed on the ground, or on some other support structure, and then placing an empty tank on top of the stand. In embodiments in which the liquid-dispensing valves are not permanently affixed to the tank, the valves can be attached directly to the tank by screwing or otherwise attaching the valves directly to the tank, or indirectly by means of a pipe or other liquid conduit.

In embodiments employing a misting system, a misting pump can be connected to the tank to draw water or another liquid from the tank, and to pump that liquid to misting nozzles. In embodiments employing a canopy, the canopy can be attached to the stand, to the tank, or otherwise put in place to provide shade over a desired area. In embodiments employing a combination canopy and misting system, the combination canopy and misting system can be assembled and put into place.

As illustrated by block 440, ice can be carried from the insulated section of the transport vehicle and put into the tank through an opening in the top of the tank. As illustrated by block 450, a pump system, pressure, a gravity fill system, or some combination thereof, can be used to fill the remaining portion of the tank with water or another liquid to be dispensed.

As illustrated by block 460, Any locks or locking mechanisms can be engaged, and valves can be properly positioned for dispensing fluids. Additionally, the misting pump can be activated if present, so that the misting system begins to operate. In some embodiments, the misting pump does not operate continuously, but operates to provide evaporative cooling when triggered by a proximity detector, in response to a timer, or in response to another suitable triggering event.

Workers may leave the site after assembling the portable liquid-dispensing station, or remain at the site to assist in operation of the dispensing station. As illustrated by block 470, after the portable liquid-dispensing station is no longer needed, the station can be disassembled, packed back onto the transport, and removed from the location. In some embodiments, the same transport used to deliver the portable liquid-dispensing station to the site is used to collect portable the liquid-dispensing stations that are done being used.

A portion of the vehicle formerly used for transporting ice or other cooling material may be empty, and therefore available for transporting rubbish left at the portable dispensing station by users of the portable liquid-dispensing station. In some such embodiments, protective liners can be placed inside the area used for holding ice or other cooling material, so that the rubbish does not dirty the holding area. Using the same transport area to deliver ice, and to collect rubbish after the portable liquid-dispensing station is done being used, can help provide a cost savings, and an additional valuable service related to the use of the portable liquid-dispensing station. Method 400 ends as illustrated by block 499.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A portable liquid-dispensing station comprising:
a portable stand capable of being carried by a single laborer;
a portable tank capable of being carried, when empty, by the laborer;
the portable stand comprising a frame having a lower portion configured to be placed on a supporting surface, and an upper portion configured to receive the portable tank and support the portable tank when filled with liquid;
the portable tank configured to be received and seated upon the upper portion of the frame, the tank comprising:
a first opening formed at an upper portion of the portable tank to receive a liquid to be dispensed;
at least a second opening formed in a lower portion of the portable tank; and
a plurality of liquid-dispensing valves spaced about at least a partial perimeter of the portable tank and in fluid communication with the at least a second opening, each of the liquid-dispensing valves independently operable to dispense the fluid in response to activation by a user.

2. The portable liquid-dispensing station of claim 1 further comprising a canopy.

3. The portable liquid-dispensing station of claim 2, wherein the canopy further comprises:
a plurality of struts fastened to separate portions of the frame, the struts extending above an uppermost portion of the tank;
a canopy frame attached to the plurality of struts, the canopy frame including support members extending on all sides beyond the outer edges of the portable tank and the portable stand;
a flexible fabric attached to the canopy frame.

4. The portable liquid-dispensing station of claim 1 further comprising a misting system configured to draw liquid from the portable tank and push the liquid through a plurality of misting nozzles.

5. The portable liquid-dispensing station of claim 4 further comprising:
an auxiliary opening formed in the portable tank;
a battery-operated pump in fluid communication with the auxiliary opening; and
a circuit of misting nozzles coupled to the battery operated pump.

6. The portable liquid-dispensing station of claim 1, further comprising:
the plurality of liquid-dispensing valves affixed to the portable tank via a plurality of second openings formed in the portable tank.

7. The portable liquid-dispensing station of claim 1, further comprising:
a conduit configured to be placed at least partially about the perimeter of the portable tank and providing fluid communication between the plurality of liquid-dispensing valves and the portable tank, the conduit comprising:
an inlet configured for connection to the at least a second opening; and
and a length along which the plurality of liquid-dispensing valves are spaced.

8. A multi-piece water dispensing system comprising:
a tank constructed to be sufficiently lightweight to be carried by a single laborer, the tank comprising:
a plurality of manually operated valves fitted through a plurality of holes spaced about a lower portion of the tank;
a fill port;
a portable stand configured to support the tank such that at least one of the plurality of manually operated valves is positioned between about waist level and shoulder level of an average-height American adult when the tank is supported by the portable stand;
a canopy; and
a misting system comprising a pump configured to be coupled to the tank and operable to draw water from the tank and deliver the water to at least one misting nozzle.

9. The multi-piece water dispensing system of claim 8, wherein a first portable stand is stackable with a second portable stand by sliding an outside portion of the first portable stand over an outside portion of the second portable stand.

10. The multi-piece water dispensing system of claim 8, wherein the fill port is an opening formed in a top portion of the tank, to receive water and ice; and further capable of being locked to secure access to the tank.

11. The multi-piece water dispensing system of claim 8, wherein the pump is a battery operated pump.

12. The multi-piece water dispensing system of claim 8, wherein the stand is between about 32 inches high and 54 inches high.

13. The multi-piece water dispensing system of claim 8, wherein the canopy comprises a free-standing canopy.

14. The multi-piece water dispensing system of claim 8, wherein the canopy is adjustable to provide shade to the tank and to a user operating the manually operated valves.

15. A method comprising:
transporting, in a single vehicle, a liquid to be dispensed, a cooling material, a dispensing container, and a container stand to a setup location, wherein both the dispensing container and the container stand are constructed to be sufficiently lightweight to be carried by a single laborer, the dispensing container comprising a plurality of dispensing valves spaced about at least a part of the lower portion of the dispensing container, and a first opening formed in an upper portion of the dispensing container;
unloading the container stand and the dispensing container;
positioning the dispensing container on the container stand such that the upper portion of the dispensing container is substantially up, and at least part of the lower portion of the dispensing container is supported by container stand;
unloading at least a portion of the cooling material from the single vehicle and putting the at least a portion of the cooling material in the dispensing container; and
at least partially filling the dispensing container from the single vehicle with the liquid to be dispensed.

16. The method of claim 15, further comprising attaching a canopy to the container stand.

17. The method of claim 15, further comprising attaching a misting system to the dispensing container, the misting system configured to draw liquid from the dispensing container.

18. The method of claim 17, wherein the misting system comprises a battery operated mister.

19. The method of claim 15, wherein the plurality of dispensing valves are carried on a pipe in fluid communication with an inside portion of the dispensing container.

20. The method of claim 15, further comprising:
removing the dispensing container from the container stand;
storing the dispensing container and the container stand on the single vehicle; collecting rubbish and placing the rubbish on the single vehicle; and
transporting the container stand, the dispensing container and the rubbish in the single vehicle.
